(19) United States
(12) Patent Application Publication
(10) Pub. No.: US 2026/0070138 A1
(43) Pub. Date: Mar. 12, 2026

(54) THREAD MILL

(71) Applicant: OSG CORPORATION, Toyokawa-City, Aichi (JP)

(72) Inventor: Masatoshi Watanabe, Toyokawa-City, Aichi (JP)

(73) Assignee: OSG CORPORATION, Toyokawa-City, Aichi (JP)

(21) Appl. No.: 19/100,259

(22) PCT Filed: Aug. 30, 2022
(86) PCT No.: PCT/JP2022/032496

§ 371 Date: Jan. 31, 2025

(51) Int. Cl. B23G 5/18

(52) U.S. Cl. CPC B23G 5/18; B23G 2200/48

(57) ABSTRACT

Provided is a thread mill that can reduce tilting of an internal thread to be machined, thus increasing the tool life. A thread mill includes a plurality of thread cutting edges that are circumferentially spaced apart on a front end side of an outer circumference of a tool body, and a plurality of end cutting edges formed at the front end of the tool body. A functional cutting edge portion that cuts a workpiece, and a non-functional cutting edge portion that is relieved toward an axial shank end relative to a trajectory of the functional cutting edge portion when the tool body is caused to make one rotation about an axis are formed on the plurality of end cutting edges.

### TECHNICAL FIELD

The present invention relates to a thread mill that can reduce tilting of an internal thread to be machined, thus increasing the tool life.

### BACKGROUND ART

Conventionally available tools for cutting internal threads in workpieces include thread mills (thread milling cutters). A thread mill includes thread cutting edges around the outer circumference of the tool body, and performs threading by being moved relative to a workpiece while being rotated about an axis by a driving apparatus such as an NC milling machine. One type of such thread mills is provided with end cutting edges on the front end face of the tool body to eliminate the need for pre-drilling performed by another tool as a preceding process of threading, and performs drilling and threading simultaneously (Patent Document 1).

The thread cutting edges of the thread mill disclosed in Patent Document 1 are formed by a plurality of threads arranged in the axial direction. Therefore, when the thread mill tilts during cutting, a pitch diameter difference between the hole entrance and the hole bottom of the cut internal thread (tilting of the internal thread) may occur.

In Patent Document 1, such tilting of the internal thread is less likely to be increased as the number of internal threads cut increases, thus ensuring longevity of the thread mill.

### PRIOR ART DOCUMENT

### Patent Document

Patent Document 1: Japanese Patent 6692932

### SUMMARY OF THE INVENTION

### Problem to be Solved by the Invention

However, the technique disclosed in Patent Document 1 is problematic in that, under certain cutting conditions, the tilting of the internal thread increases at an early stage as the number of internal threads cut increases, resulting in a shorter tool life. Presumably, one reason for this is that, during a cutting operation using the thread mill, the cutting amount of the workpiece by one end cutting edge per one thread cutting edge of the thread mill when the thread mill makes one rotation (hereinafter referred to as “one turn”) about an axis is excessively small.

The present invention has been made to solve the above-described problem, and an object of the invention is to provide a thread mill that can reduce tilting of an internal thread to be machined, thus increasing the tool life.

### Means for Solving the Problem

In order to achieve this object, a thread mill according to the present invention cuts an internal thread in a workpiece by moving relative to the workpiece while rotating about an axis. The thread mill includes: a tool body including an axial front end, and a shank end located axially opposite to the front end, and having a shaft shape centered around the axis; a plurality of thread cutting edges that are each formed by a plurality of axially arranged threads, and that are circumferentially spaced apart on the front end side of an outer circumference of the tool body; and a plurality of end cutting edges formed at the front end of the tool body so as to be respectively connected with the plurality of thread cutting edges on the front end side. A functional cutting edge portion that cuts the workpiece, and a non-functional cutting edge portion that is axially relieved toward the shank end side relative to a trajectory of the functional cutting edge portion when the tool body is caused to make one rotation about the axis are formed on the plurality of end cutting edges.

### Advantageous Effects of the Invention

With the thread mill according to claim 1, the functional cutting edge portion and the non-functional cutting edge portion are formed on the plurality of end cutting edges respectively connected with the plurality of thread cutting edges. The non-functional cutting edge portion is relieved toward the axial shank end relative to the trajectory of the functional cutting edge portion when the tool body is caused to make one rotation (during one turn) about an axis. Consequently, depending on the cutting conditions, the non-functional cutting edge portion is less likely to cut the workpiece, whereas the functional cutting edge portion cuts the workpiece. Accordingly, the cutting amount of the workpiece by one functional cutting edge portion during one turn is increased when the non-functional cutting edge portion is provided than when no non-functional cutting edge portion is provided and the plurality of end cutting edges are entirely constituted by the functional cutting edge portion. Thus, with this thread mill, it is possible to reduce tilting of an internal thread to be machined, thus increasing the tool life.

The thread mill according to claim 2 provides the following effect, in addition to the effect provided by the thread mill according to claim 1. Here, when the functional cutting edge portion and the non-functional cutting edge portion are formed on one end cutting edge, it is difficult to ensure the relief of the non-functional cutting edge portion toward the shank end in the vicinity of the boundary therebetween. In contrast, each of the end cutting edges of the present thread mill is entirely (except for a gash cutting edge described below) formed by either the functional cutting edge portion or the non-functional cutting edge portion. Accordingly, the relief of the non-functional cutting edge portion toward the shank end can be easily ensured, so that the non-functional cutting edge portion is less likely to come into contact with the workpiece during a cutting operation using the thread mill. Consequently, the amount of cutting by the functional cutting edge portion during one turn can be easily ensured.

The thread mill according to claim 3 provides the following effect, in addition to the effect provided by the thread mill according to claim 1 or 2. The rake faces of the plurality of end cutting edges are respectively formed by the plurality of gashes recessed at the front end of the tool body. Furthermore, each of the gases includes a gash face and a flute bottom. The gash face is circumferentially opposed to the corresponding rake face, and the opposed interval between the gash face and the rake face is narrowed toward the shank end. The flute bottom joins the gash face and the rake face, extends from the axis side of the tool body toward the outer circumference thereof, and is inclined toward the shank end.

The plurality of gashes are in communication with each other on the axis side thereof. Thus, a ridge between the rake face of one of two gashes circumferentially adjacent to each other, and the gash face of the other gash is formed. The ridge is referred to as a gash cutting edge. The plurality of gash cutting edges are respectively connected with the plurality of end cutting edges. Trajectories of the plurality of gash cutting edges when the tool body is caused to make one rotation overlap each other at least on the end cutting edge side. In the case of cutting the workpiece not only by the end cutting edges but also by the gash cutting edges on the end cutting edge side thereof, each of the plurality of gash cutting edges can be easily brought into contact with the workpiece, and the radial deformation of the tool body corresponding to the manner of such contact can be made as uniform as possible in the circumferential direction. Accordingly, it is possible to prevent the occurrence of vibration induced by such nonuniform radial deformation, thus suppressing a reduction in the tool life due to such vibration.

The thread mill according to claim 4 provides the following effect, in addition to the effect provided by the thread mill according to claim 3. Each of the end cutting edges is entirely (except for the gash cutting edge) formed by either the functional cutting edge portion or the non-functional cutting edge portion. Accordingly, as described above, the relief of the non-functional cutting edge portion toward the shank end can be easily ensured, so that the amount of cutting by the functional cutting edge portion during one turn can be easily ensured.

Since the non-functional cutting edge portion is less likely to cut the workpiece, a relatively small amount of chips is housed in the gash forming the rake face of the non-functional cutting edge portion. Chips produced by cutting with the functional cutting edge portion are mainly housed in the gash forming the rake face of the functional cutting edge portion, and therefore a relatively large amount of chips is housed in the gash. Here, the depth, from the front end side to the flute bottom, of the gash forming the rake face of the functional cutting edge portion is larger than the depth, from the front end side to the flute bottom, of the gash forming the rake face of the non-functional cutting edge portion. Thus, it is possible to increase the internal space of the gash in which a large amount of chips is housed, while reducing the internal space of the gash in which a small amount of chips is housed. Accordingly, it is possible to prevent clogging of chips during a cutting operation with the thread mill, and ensure the rigidity of the tool body, thus increasing the tool life of the thread mill.

The thread mill according to claim 5 provides the following effect, in addition to the effect provided by the thread mill according to any one of claims 1 to 4. The functional cutting edge portion and the non-functional cutting edge portion are disposed circumferentially alternately. Thus, during a cutting operation, the positions at which the plurality of thread cutting edges come into contact with the workpiece can be about half the positions at which the functional cutting edge portion come into contact with the workpiece in the circumferential direction. Accordingly, it is possible to reduce the load concentration on a part of the thread mill in the circumferential direction during cutting, thus increasing the tool life.

The thread mill according to claim 6 provides the following effect, in addition to the effect provided by the thread mill according to any one of claims 1 to 5. The plurality of end cutting edges are formed rotationally symmetrical about the axis. Thus, the functional cutting edge portion and the non-functional cutting edge portion are located rotationally symmetrical, and therefore the reaction force received by the functional cutting edge portion from the workpiece during a cutting operation can be made as uniform as possible in the circumferential direction. Accordingly, with the thread mill, it is possible to reduce the load concentration on part of the functional cutting edge portions during cutting, thus increasing the tool life.

If the displacement of a plurality of end cutting edges from their rotationally symmetrical position is 2° or less, this is defined to mean that the “plurality of end cutting edges are formed rotationally symmetrical about the axis”.

### BRIEF DESCRIPTION OF THE DRAWINGS

FIG. 1 A front view of a thread mill according to a first embodiment.

FIG. 2 An enlarged front view of the thread mill, showing the section II in FIG. 1.

FIG. 3 A bottom view of the thread mill as viewed in the direction of the arrow III in FIG. 1.

FIG. 4 A cross-sectional view of the thread mill taken along the line IV-IV in FIG. 3.

FIG. 5 A partial enlarged front view of a thread mill according to a second embodiment.

FIG. 6 A partial enlarged front view of a thread mill according to a third embodiment.

FIG. 7 A partial enlarged front view of a thread mill according to a fourth embodiment.

FIG. 8 A partial enlarged front view of a thread mill according to a fifth embodiment.

### MODES FOR CARRYING OUT THE INVENTION

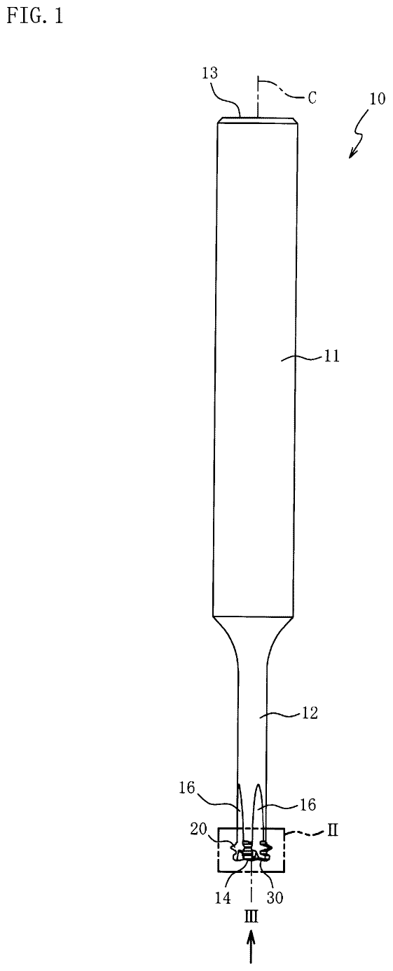

Hereinafter, preferred embodiments will be described with reference to the accompanying drawings. FIG. 1 is a front view of a thread mill according to the first embodiment. A thread mill 10 is a tool for cutting an internal thread in a workpiece by means of rotational force transmitted from a driving apparatus such as an NC milling machine and a machining center.

The thread mill 10 is made of cemented carbide obtained by pressing and sintering tungsten carbide or the like. The material of the thread mill 10 is not limited to cemented carbide, and the thread mill 10 may be made of, for example, high-speed tool steel.

The thread mill 10 includes a tool body 12 having a shaft shape centered around an axis C, and a first cutting edge portion 20 and a second cutting edge portion 30 for cutting a workpiece. In the following description, the direction of the axis C is simply referred to as an “axial direction”.

The tool body 12 is a shaft-like part having an axial front end 14 (lower end portion in FIG. 1), and a shank end 13 (upper end portion in FIG. 1) located axially opposite to the front end 14. The front end 14 of the tool body 12 also constitutes a front end of the thread mill 10. On the front end 14 side of the tool body 12, the first cutting edge portion 20, the second cutting edge portion 30, and a plurality of flutes 16 are provided.

A portion of the tool body 12 that is located on the shank end 13 side is referred to as a shank 11, and a portion extending from the shank 11 to the front end 14 is referred to as an under-head portion. The shank 11 is formed in a columnar shape having a substantially constant outer diameter along the axis C. The under-head portion is formed in a columnar shape having a substantially constant outer diameter along the axis C except for a joining portion thereof with the shank 11. The joining portion of the under-head portion is tapered such that the diameter thereof decreases toward the front end 14. Accordingly, the outer diameter of the under-head portion on the front end 14 side relative to the joining portion is smaller than the outer diameter of the shank 11.

The shank 11 and the under-head portion may be each formed in a cylindrical shape, and the outer diameter of the under-head portion may be greater than or equal to the outer diameter of the shank 11. The shank 11 is not limited to having a substantially constant outer diameter along the axis C, and the shank 11 may be tapered such that the outer diameter expands toward the front end 14, for example.

The shank 11 is held by the driving apparatus. The thread mill 10 having the shank 11 held by the driving apparatus cuts an internal thread in a workpiece using driving force transmitted from the driving apparatus. The driving force from the driving apparatus rotates (turns) the thread mill 10 about the axis C, and helically feeds the thread mill 10 to move the thread mill 10 relative to the workpiece. Helical feeding means allowing the thread mill 10 to swing (revolve) about the central axis of an internal thread to be formed, while lead-feeding the thread mill 10 in the axial direction.

The flutes 16 are grooves for discharging chips produced as a result of the workpiece having been cut by the first cutting edge portion 20 and the second cutting edge portion 30. The flutes 16 are formed by partially cutting out the outer circumferential face of the columnar tool body 12 along the axis C from the front end 14 toward the shank end 13. The plurality of flutes 16 divide the first cutting edge portion 20 into a plurality of (in the present embodiment, four) sections in the circumferential direction of the tool body 12.

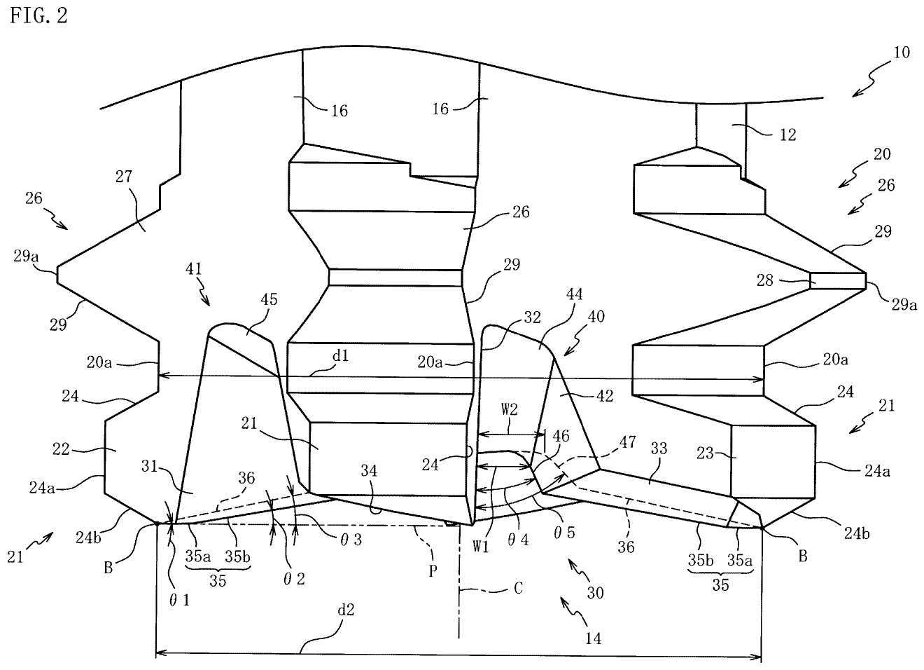

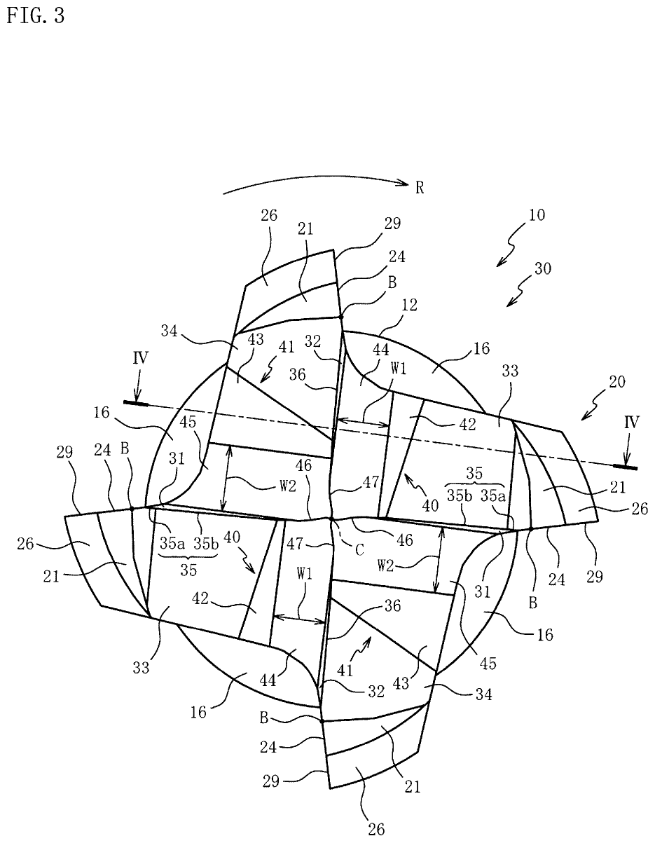

Next, the first cutting edge portion 20 and the second cutting edge portion 30 will be described with reference to FIGS. 2 and 3. FIG. 2 is a partial enlarged front view of the thread mill 10, showing the section II in FIG. 1. FIG. 3 is a bottom view of the thread mill 10 as viewed in the direction of the arrow III in FIG. 1. The upper side of the drawing sheet of FIG. 2 corresponds to the shank end 13 side.

As shown in FIG. 2, the first cutting edge portion 20 is a part that cuts an internal thread in the inner circumferential face of a drill hole formed by the second cutting edge portion 30. The first cutting edge portion 20 includes a plurality of thread portions projecting radially outward from the front end 14 side of the outer circumference of the tool body 12. Each of the plurality of thread portions is formed by two threads, composed of a front thread portion 21 forming one thread on the front end 14 side, and a rear thread portion 26 forming one thread on the shank end 13 side. The front thread portions 21 and the rear thread portions 26 are disposed between the corresponding ones of the plurality of flutes 16.

The front thread portions 21 each include a front rake face 22, a front flank face 23, and a front cutting edge 24 formed by a ridge between the front rake face 22 and the front flank face 23. The rear thread portions 26 each include a rear rake face 27, a rear flank face 28, and a rear cutting edge 29 formed by a ridge between the rear rake face 27 and the rear flank face 28.

The front rake faces 22 and the rear rake faces 27 are parts for producing and discharging chips when a workpiece is cut by the front cutting edges 24 and the rear cutting edges 29, respectively. The front rake faces 22 and the rear rake faces 27 are located on the forward side of the outer surfaces of the front thread portions 21 and the rear thread portions 26, respectively, in a rotation direction R (clockwise direction in FIG. 3) during cutting, and are connected with the wall faces of the flutes 16.

The front flank faces 23 and the rear flank faces 28 are parts for reducing the contact area between the first cutting edge portion 20 and a workpiece when the workpiece is cut by the front cutting edges 24 and the rear cutting edges 29, respectively. The front flank faces 23 and the rear flank faces 28 are located on the outer circumference side of the outer surfaces of the front thread portions 21 and the rear thread portions 26, respectively.

The front cutting edges 24 and the rear cutting edges 29 are parts that bite into a workpiece to cut the workpiece. Roots 20a that are ridges connecting the front cutting edges 24 with the corresponding rear cutting edges 29 in the axial direction also cut the workpiece. The height from the roots 20a to crests 24a of the front cutting edges 24 is smaller than the height from the roots 20a to crests 29a of the rear cutting edges 29.

A front cutting edge 24, a rear cutting edge 29, and a root 20a described above constitute a thread cutting edge formed of a plurality of axially arranged threads for cutting an internal thread in a workpiece. Hereinafter, when referring to the entire thread cutting edge, it is referred to as a “thread cutting edge 24”.

The thread mill 10 including a plurality of thread cutting edges 24 spaced apart in the circumferential direction is helically fed while turning, thus cutting an internal thread in a workpiece. Specifically, first, the workpiece is roughly cut by the front cutting edges 24. Thereafter, the roughly cut portions are subjected to finish cutting by the rear cutting edges 29, thus threading the workpiece. The rough cutting and the finish cutting can reduce the load on the rear cutting edges 29. This results in reduced wear of the rear cutting edges 29, thus making it possible to increase the cutting accuracy of the thread cutting edges 24.

As shown in FIGS. 2 and 3, the second cutting edge portion 30 is a part that cuts a drill hole having a diameter corresponding to the inner diameter of the internal thread. The second cutting edge portion 30 is formed at the front end 14 of the tool body 12 so as to be circumferentially divided by a plurality of (in the present embodiment, four) gashes 40, 41 recessed at the front end 14. The plurality of gashes 40, 41, the details of which will be described below, are grooves that extend from the axis C side toward the outer circumference of the tool body 12, and that are respectively open to the plurality of flutes 16.

The second cutting edge portion 30 includes a plurality of rake faces 31, 32, a plurality of flank faces 33, 34, and a plurality of first end cutting edges 35 and second end cutting edges 36. Ridges between the rake faces 31 and the corresponding flank faces 33 form the first end cutting edges 35. Ridges between the rake faces 32 and the corresponding flank faces 34 form the second end cutting edges 36.

A set composed of a rake face 31, a flank face 33, and a first end cutting edge 35, and a set composed of a rake face 32, a flank face 34, and a second end cutting edge 36 are disposed circumferentially alternately. Furthermore, two sets, each including the first end cutting edge 35, and two sets, each including the second end cutting edge 36, are provided, and these sets are formed rotationally symmetrical about the axis C.

In the present specification, to be rotationally symmetric, for example, the positions of the first end cutting edges 35 and the second end cutting edges 36 in FIG. 3 need not be completely identical to the positions of the first end cutting edges 35 and the second end cutting edges 36 when the thread mill 10 is rotated by 180° about the axis from the state shown in FIG. 3. For example, if the positional displacement between the two states is 2° or less, this means that a “plurality of first end cutting edges 35 and second end cutting edges 36 are formed rotationally symmetrical”.

The rake faces 31, 32 are parts for producing and discharging chips when a workpiece is cut by the first end cutting edge 35 and the second end cutting edge 36. The rake faces 31, 32 are oriented to the forward side, in the rotation direction R, of the outer surface of the second cutting edge portion 30. The rake faces 31 are formed by the gashes 41. The rake faces 32 are formed by the gashes 40.

The flank faces 33, 34 are parts for reducing the contact area between the second cutting edge portion 30 and a workpiece when the workpiece is cut by the first end cutting edges 35 and the second end cutting edges 36. The flank faces 33 are inclined upward to the shank end 13 side in a direction circumferentially away from the first end cutting edges 35 (rearward in the rotation direction R). The flank faces 34 are inclined upward to the shank end 13 side in a direction circumferentially away from the second end cutting edges 36. The flank faces 33, 34 form portions of the front end 14 of the tool body 12.

The first end cutting edges 35 are parts that bite into a workpiece to cut the workpiece. The first end cutting edges 35 each include an outer end cutting edge 35a connected with a flank 24b of a front cutting edge 24 on the front end 14 side, and an inner end cutting edge 35b connected with an outer end cutting edge 35a on the axis C side

A diameter d2 at the position of a boundary B between the outer end cutting edges 35a of the first end cutting edges 35 and the flanks 24b is greater than or equal to a minor diameter d1 of the roots 20a. The minor diameter d1 is twice the radial distance from the axis C to the roots 20a.

The diameter d2 is twice the radial distance from the axis C to the boundary B. The diameter at the position of the boundary B between the second end cutting edges 36 and the flanks 24b is substantially identical to the diameter d2 (slightly larger than the diameter d2).

Here, the axial bracing force generated in the thread mill 10 during cutting is larger on the axis C side relative to the boundary B. Accordingly, when the diameter d2 is greater than or equal to the minor diameter d1 of the roots 20a, the axial bracing force generated in the thread mill 10 can be more easily located radially outward than when the diameter d2 is smaller than the minor diameter d1. Therefore, with this bracing force, the thread mill 10 can be made less likely to tilt relative to the central axis of an internal thread to be cut. This makes it possible to reduce the pitch diameter difference (tilting of the internal thread) between the hole entrance and the hole bottom of an internal thread cut by the thread mill 10, thus increasing the tool life of the thread mill 10.

Each of the pitch diameter of the hole entrance of an internal thread, and the pitch diameter of the hole bottom of an internal thread is measured using a known step gauge. The difference between the measured results of these pitches is a “pitch diameter difference between the hole entrance and the hole bottom of an internal thread”.

Since the diameter d2 and the minor diameter dl are substantially identical in the present embodiment, the boundary B, which is the starting location of the flanks 24b of the front cutting edges 24 can be prevented from being located radially outward of the roots 20a. This can reduce the load concentration on the flanks of the rear cutting edges 29 that cut portions uncut by the flanks 24b. Consequently, the durability of the thread cutting edges 24 such as the rear cutting edges 29 can be ensured, thus making it possible to increase the tool life of the thread mill 10.

An angle θ1 between each of the outer end cutting edges 35a and a virtual plane P orthogonal to the axis C is set to 0° or more and 6° or less (in the present embodiment, 1°). The angle θ1 is measured on a plane orthogonal to the virtual plane P and passing through the outer end cutting edges 35a. The angle θ1 takes a positive value when the outer end cutting edges 35a are inclined upward to the shank end 13 side toward the axis C. The angle θ1 may be set to take a negative value.

The inner end cutting edges 35b are parts that cut a workpiece while reducing the cutting resistance of the first end cutting edges 35. The inner end cutting edges 35b are more significantly inclined to the shank end 13 side toward the axis C than the outer end cutting edges 35a are. That is, the angle θ2 between each of the inner end cutting edges 35b and the virtual plane P is greater than the angle θ1. The angle θ2 is measured on a plane orthogonal to the virtual plane P and passing through the inner end cutting edges 35b.

When starting a cutting operation of a workpiece using the thread mill 10, first, the outer end cutting edges 35a, which have a smaller angle θ1 relative to the virtual plane P, substantially linearly come into contact with the workpiece to cut the workpiece. Thereafter, as the cutting operation proceeds, the inner end cutting edges 35b, which have a larger angle θ2 relative to the virtual plane P, also come into contact with the workpiece, thus increasing the cutting range of the first end cutting edges 35. The closer the angle θ1 of the outer end cutting edges 35a coming into contact with the workpiece at the beginning of a cutting operation using the thread mill 10 is to 0°, the more easily the entire outer end cutting edges 35a come into contact with the workpiece substantially at once, and the more wear resistant the first end cutting edges 35 will be.

The second end cutting edges 36 are parts that basically do not function as an end cutting edge that cuts a workpiece. Hereinafter, a part that does not function as an end cutting edge is referred to as a non-functional cutting edge portion, and a part that functions as an end cutting edge is referred to as a functional cutting edge portion. This means that the second end cutting edges 36 are entirely constituted by non-functional cutting edge portions, and the first end cutting edges 35 are entirely constituted by functional cutting edge portions.

Note that depending on the cutting condition when cutting a workpiece using the thread mill 10, and the degree of wear of the first end cutting edges 35, the second end cutting edges 36 may also function as end cutting edges (may cut a workpiece). However, unless otherwise specified, the following describes conditions under which the second end cutting edges 36 do not function as end cutting edges.

FIG. 2 shows a case where the first end cutting edges 35 are located on left and right sides on the drawing sheet relative to the axis C. Additionally, in FIG. 2, the second end cutting edges 36 when the thread mill 10 (tool body 12) is caused to turn by 90° about the axis C from the aforementioned state without being helically fed are indicated by broken lines. That is, in FIG. 2, the second end cutting edges 36 located on left and right sides on the drawing sheet relative to the axis C are indicated by broken lines.

As shown in FIG. 2, the second end cutting edges 36 are relieved toward the axial shank end 13 relative to the first end cutting edges 35. More specifically, the second end cutting edges 36 are relieved toward the axial shank end 13 relative to the trajectories of the first end cutting edges 35 when the thread mill 10 is caused to make one rotation (during one turn) about the axis C without being helically fed. Consequently, the second end cutting edges 36 cease to cut the workpiece although this depends on the cutting conditions.

Conventional thread mills are not provided with such second end cutting edges 36, and all of the plurality of end cutting edges are constituted by the first end cutting edges 35. During a cutting operation using the conventional thread mills, the cutting amount of a workpiece during one turn by one first end cutting edge 35 per one thread cutting edge 24 is excessively small. Due to this, under some cutting conditions, the tilting of internal threads may increase at an early stage with an increase in the number of internal threads cut.

The increase in tilting of the internal thread becomes pronounced when the hardness of the workpiece is 60HRC or more. The HRC is a unit of Rockwell hardness using a C scale. Also, the increase in tilting of the internal thread is more pronounced when the tool body 12 has a narrower under-head portion. In particular, when the under-head portion has a tool diameter of 6.2 mm (a minor diameter d1 of 4.81 mm) or less, the increase in tilting of the internal thread becomes pronounced. The tool diameter is twice the radial distance from the axis C to the crest 29a of the rear cutting edge 29.

The longer the axial dimension of the under-head portion of the tool body 12, the more pronounced the increase in tilting of internal threads becomes. In particular, the increase in tilting of internal threads is pronounced when the axial dimension is larger than three times the minimum nominal diameter of internal threads that can be cut by the thread mill 10. In order to cut an internal thread having a large nominal diameter, it is preferable to increase the tool diameter of the tool body 12. Accordingly, it can be said that the increase in tilting of internal threads is likely to be pronounced when the axial dimension of the under-head portion of the tool body 12 is larger than 4 to 4.5 times the tool diameter of the tool body 12.

Here, unlike the thread mill 10, for an end mill that does not perform threading, the axial feed rate during one turn may be increased in order to increase the cutting amount by the end cutting edges during one turn. In contrast, for the thread mill 10 that performs threading and axial cutting simultaneously, the axial feed rate needs to be set according to the threading shape, and therefore there is a limit on the increase in the amount of cutting by one end cutting edge.

However, with the thread mill 10 according to the present embodiment, the second end cutting edges 36 do not cut a workpiece, so that the cutting amount of the workpiece by one first end cutting edge 35 during one turn is increased as compared with the conventional thread mills in which all of the end cutting edges are the first end cutting edges 35. Accordingly, with the thread mill 10, it is possible to reduce tilting of an internal thread to be cut, thus increasing the tool life.

Each of the second end cutting edge 36 is formed in a straight line from the boundary B between the flank 24b of the corresponding front cutting edge 24 toward the axis C. An angle θ3 between the second end cutting edge 36 and the virtual plane P is greater than both the angles θ1 and θ2. The angle θ3 is measured on a plane orthogonal to the virtual plane P and passing through the second end cutting edge 36.

With such a relationship between the angle θ3 and the angles θ1 and θ2, the second end cutting edge 36 can be easily relieved toward the shank end 13 over the entire length of the first end cutting edge 35. Consequently, the second end cutting edge 36 can be suppressed from partially coming into contact with the workpiece, thus making it possible to ensure the amount of cutting by the first end cutting edge 35 during one turn.

The first end cutting edges 35 constituted by the functional cutting edge portions, and the second end cutting edges 36 constituted by the non-functional cutting edge portions are disposed circumferentially alternately. Thus, during a cutting operation, the positions at which the first end cutting edges 35 come into contact with the workpiece can be about half the positions at which the plurality of thread cutting edges 24 come into contact with the workpiece in the circumferential direction. Accordingly, it is possible to reduce the load concentration on part of the thread mill 10 in the circumferential direction during a cutting operation, thus increasing the tool life of the thread mill 10.

The plurality of first end cutting edges 35 and second end cutting edges 36 are arranged rotationally symmetrical about the axis C. Thus, the reaction force received by the first end cutting edges 35 from the workpiece during a cutting operation can be made as uniform as possible in the circumferential direction.

In addition, the respective thread cutting edges 24 are connected with both the first end cutting edges 35 and second end cutting edges 36 described above, and therefore the plurality of thread cutting edges 24 are also arranged rotationally symmetrical about the axis C. Thus, the reaction force received by the thread cutting edges 24 from the workpiece during a cutting operation can be easily made as uniform as possible in the circumferential direction. As a result of these, it is possible to reduce the load concentration on part of the first end cutting edges 35 and the thread cutting edges 24 during a cutting operation using the thread mill 10, thus increasing the tool life of the thread mill 10.

Here, when both the functional cutting edge portion and the non-functional cutting edge portion are formed on one end cutting edge (e.g., in the cases of the first end cutting edges 62, 72 and second end cutting edges 52, 63, 74 of second to fourth embodiments), it is difficult to ensure relief of the non-functional cutting edge portion toward the shank end 13 in the vicinity of the boundary between the functional cutting edge portion and the non-functional cutting edge portion.

In contrast, in the case of the thread mill 10 according to the present embodiment, the first end cutting edges 35 are entirely formed by the functional cutting edge portions, and the second end cutting edges 36 are entirely formed by the non-functional cutting edge portions. Accordingly, the relief of the second end cutting edges 36 (non-functional cutting edge portions) toward the shank end 13 can be easily ensured, so that the second end cutting edges 36 are less likely to come into contact with the workpiece during a cutting operation using the thread mill 10. Consequently, the cutting amount by the first end cutting edges 35 (functional cutting edge portions) during one turn can be easily ensured.

The second end cutting edges 36 are relieved from the boundary B toward the shank end 13 relative to the first end cutting edges 35. That is, the plurality of thread cutting edges 24 located radially outward of the boundary B have substantially identical shapes. Accordingly, the load exerted on the plurality of thread cutting edges 24 during a cutting operation using the thread mill 10 can be easily made uniform, thus making it possible to increase the tool life of the thread mill 10.

In actuality, in the present embodiment, the boundary B between each of the second end cutting edges 36 and the corresponding flank 24b is located slightly radially outward relative to the boundary B between each of the first end cutting edges 35 and the corresponding flank 24b. For example, the radial distance between the boundaries B is preferably less than or equal to 1/2 of the radial dimension of the flanks 24b. Such a positional relationship between the boundaries B can further prevent the second end cutting edges 36 from coming into contact with the workpiece.

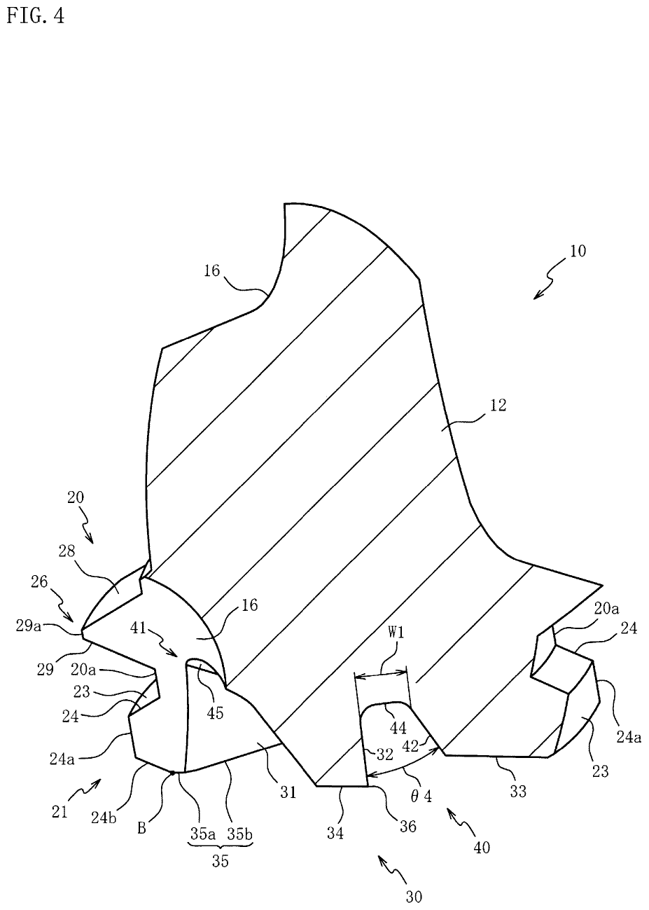

Next, the gashes 40, 41 will be described with reference to FIGS. 2 to 4. FIG. 4 is a cross-sectional view of the thread mill 10 taken along the line IV-IV in FIG. 3.

As shown in FIGS. 2 and 3, a plurality of gashes 40, 41 are grooves formed at the front end 14 of the tool body 12. Each of the gashes 40 includes the rake face 32 described above, a gash face 42 to which the rake face 32 is circumferentially opposed, and a flute bottom 44 joining the gash face 42 and the rake face 32. Similarly, each of the gashes 41 includes the rake face 31 described above, a gash face 43 to which the rake face 31 is circumferentially opposed, and a flute bottom 45 joining the gash face 43 and the rake face 31. The gash faces 42, 43 are located on the heel side (rear side of the flank faces 33, 34 in the rotation direction R) of the faces formed by the gashes 40, 41.

The axis C side of a gash 40 is in communication with the rake face 31 of the gash 41 that is adjacent to that gash 40 on the front side in the rotation direction R. Similarly, the axis C side of a gash 41 is in communication with the rake face 32 of the gash 40 that is adjacent to that gash 41 on the front side in the rotation direction R.

Thus, a ridge between the gash face 42 and the flute bottom 44 of the gash 40 and the rake face 31 of the gash 41 is formed. This ridge is referred to as a gash cutting edge 46. The gash cutting edge 46 is connected with an end of the first end cutting edge 35 on the axis C side. Similarly, the gash cutting edge 47 formed by the ridge between the gash face 43 and the flute bottom 45 and the rake face 32 is connected with an end of the second end cutting edge 36 on the axis C side. In FIG. 2, the gash cutting edge 47 connected with the second end cutting edge 36 is also indicated by a broken line.

The flute bottoms 44, 45 are substantially flat faces that extend from the radially inner side of the tool body 12 (axis C side) toward the outer circumference of the tool body 12, and that are inclined at a constant gradient toward the shank end 13. Although not shown, the angle of the gradient of the flute bottoms 44, 45 relative to the virtual plane P is a gash angle. In the present embodiment, the gash angle of the flute bottom 44 and the gash angle of the flute bottom 45 are identical. Note that the flute bottom 44 and the flute bottom 45 may have different gash angles.

The width W1 of a flute bottom 44 is the dimension in a direction perpendicular to the direction of the gradient of the flute bottom 44. The width W2 of a flute bottom 45 is the dimension in a direction perpendicular to the direction of the gradient of the flute bottom 45. FIG. 2 schematically shows the width W1 of the flute bottom 44 on the gash cutting edge 46, and the width W2 of the flute bottom 45 on the gash cutting edge 47.

FIG. 4 shows a cross section parallel to the direction of the width W1 and perpendicular to the gradient of the flute bottom 44. As in this cross section, the opposed interval between the rake face 32 and the gash face 42 is narrowed toward the shank end 13 (flute bottom 44). Furthermore, the angle between the rake face 32 and the gash face 42 in the cross section shown in FIG. 4 is defined as a gash opening angle θ4. The gash opening angle θ4 is also an angle between the rake face 32 extended toward the axis C and part of the gash cutting edge 46. Accordingly, FIG. 2 schematically shows the gash opening angle θ4.

The same applies to the gash 41. Specifically, in a cross section parallel to the width W2 and perpendicular to the gradient of the flute bottom 45, the opposed interval between the rake face 31 and the gash face 43 is narrowed toward the shank end 13 (flute bottom 45). Furthermore, the gash opening angle θ5, which is an angle between the rake face 31 and the gash face 43 in a cross section perpendicular to the gradient of the flute bottom 45, is also an angle between the rake face 31 extended toward the axis C and the gash cutting edge 47. Accordingly, FIG. 2 schematically shows the gash opening angle θ5.

Depending on the cutting conditions (e.g., when the inner diameter of a drill hole for an internal thread to be cut is less than or equal to 1.5 times the minor diameter dl), the gash cutting edges 46, 47 connected with the first end cutting edge 35 and the second end cutting edge 36 may also cut the workpiece during a cutting operation using the thread mill 10. However, at portions other than flute bottoms 44, 45, the gash cutting edge 47 is relieved toward the shank end 13 and radially outward, relative to the gash cutting edge 46, as in the case of the second end cutting edge 36 relative to the first end cutting edge 35. Accordingly, the gash cutting edge 47 is less likely to cut the workpiece.

This is because the depths (distance from the front end 14 side to the flute bottoms 44, 45) of the gashes 40, 41 are substantially identical to each other, and the gash opening angle θ5 at the gash 41 (gash cutting edge 47) and the width W2 of the flute bottom 45 are larger than the gash opening angle θ4 at the gash 40 (gash cutting edge 46) and the width W1 of the flute bottom 44, respectively. Note that when the gash opening angles θ4, θ5 are identical, and the width W2 is increased relative to the width W1, the gash cutting edge 47 is also less likely to cut the workpiece. When the widths W1, W2 are identical, and the gash opening angle θ5 is increased relative the gash opening angle θ4, the gash cutting edge 47 is also less likely to cut the workpiece. As in these cases, states in which at least one of the gash opening angle θ5 and the width W2 is large are collectively referred to as a “state in which the gash 41 is increased relative to the gash 40” or a “state in which the gash cutting edge 47 is relieved from the gash cutting edge 46”.

In a state in which the gash cutting edge 47 is relieved relative to the gash cutting edge 46, the cutting amount of the workpiece by the gash cutting edge 46 during one turn can be increased due to the fact that the gash cutting edge 47 is less likely to cut the workpiece as compared to the gash cutting edge 46, as in the case of the first end cutting edge 35. Accordingly, the tool life of the thread mill 10 may be increased.

The gashes 40, 41 form chip rooms for housing chips produced by cutting the workpiece. Since the gash 41 is large relative to the gash 40, the chip room formed by the gash 41 can be widened. Accordingly, it is possible to prevent clogging of chips during a cutting operation using the thread mill 10.

The chip room formed by the gash 41 can be further widened when the width W2 is increased relative to the width W1, as compared with a case where the gash opening angle θ5 is simply increased relative to the gash opening angle θ4. Accordingly, in this case, it is possible to further prevent clogging of chips during a cutting operation using the thread mill 10.

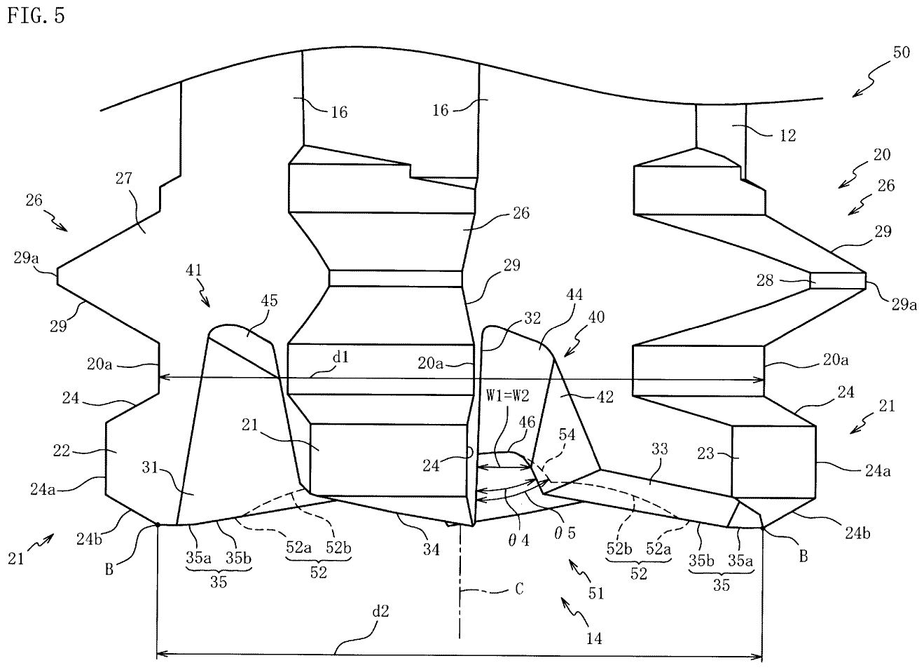

Next, a second embodiment will be described with reference to FIG. 5. The first embodiment describes a case where each of the second end cutting edges 36 is entirely constituted by the non-functional cutting edge portion. In contrast, the second embodiment describes a case where a part of each of the second end cutting edges 52 is constituted by a functional cutting edge portion 52a, and another part thereof is constituted by a non-functional cutting edge portion 52b. Portions that are identical to those described in the first embodiment are denoted by identical reference characters, and descriptions thereof have been omitted.

FIG. 5 is a partial enlarged front view of a thread mill 50 according to the second embodiment. The upper side on the drawing sheet of FIG. 5 corresponds to the shank end 13 side. Also, FIG. 5 shows a case where the first end cutting edges 35 are located on left and right sides on the drawing sheet relative to the axis C. Additionally, in FIG. 5, the second end cutting edges 52 when the thread mill 50 (tool body 12) is caused to turn by 90° about the axis C from the aforementioned state without being helically fed are indicated by broken lines.

The second cutting edge portion 51 of the thread mill 50 is a part that cuts a drill hole having a diameter corresponding to the inner diameter of the internal thread. Similarly to the first embodiment, the second cutting edge portion 51 is formed at the front end 14 of the tool body 12 so as to be circumferentially divided by a plurality of (in total, four) gashes 40, 41 recessed at the front end 14.

The dimensions of the gashes 40, 41 in the second embodiment are partially different from those of the gashes 40, 41 in the first embodiment, but are denoted by identical reference characters in the two embodiments in order to simplify the description of the gashes 40, 41. The same applies to third to fifth embodiments described below.

The second cutting edge portion 51 includes a plurality of rake faces 31, 32, a plurality of flank faces 33, 34, and a plurality of first end cutting edges 35 and second end cutting edges 52. Ridges between the rake faces 32 and the corresponding flank faces 34 form the second end cutting edges 52. The first end cutting edges 35 and the second end cutting edges 52 are disposed circumferentially alternately, and are formed rotationally symmetrical about the axis C.

The second end cutting edges 52 are parts whose portions bite into a workpiece to cut the workpiece. The second end cutting edges 52 each include a functional cutting edge portion 52a connected with a flank 24b of the front cutting edge 24, and a non-functional cutting edge portion 52b connected with the axis C side of the functional cutting edge portion 52a.

The functional cutting edge portions 52a are formed identical to the outer end cutting edges 35a of the first end cutting edges 35, and radially outward portions of the inner end cutting edges 35b. That is, the functional cutting edge portions 52a overlap the trajectories of the first end cutting edges 35 when the thread mill 50 is caused to make one rotation about the axis C without being helically fed. Accordingly, the functional cutting edge portions 52a cut the workpiece during a cutting operation using the thread mill 50.

The non-functional cutting edge portions 52b are parts that are recessed toward the shank end 13 relative to the functional cutting edge portions 52a. The non-functional cutting edge portions 52b are relieved toward the axial shank end 13 relative to the trajectories of the first end cutting edges 35 when the thread mill 50 is caused to make one rotation about the axis C without being helically fed. Consequently, depending on the cutting conditions, the non-functional cutting edge portions 52b no longer cut the workpiece.

Thus, the cutting amount of the workpiece during one turn is increased at parts (portions on the axis C side) of the first end cutting edges 35 that correspond to the non-functional cutting edge portions 52b. Consequently, with the thread mill 50, it is possible to reduce tilting of an internal thread to be cut, thus increasing the tool life.

Since the thread mill 50 cuts a workpiece by turning while being helically fed, the cutting amount of the workpiece during one turn is smaller on the axis C side of the first end cutting edges 35 than the radially outer side thereof when there are no second end cutting edges 52. In contrast, when there are second end cutting edges 52, the cutting amount of the workpiece by the first end cutting edges 35 during one turn is increased by the non-functional cutting edge portions 52b of the second end cutting edges 52 on the axis C side, while being maintained by the functional cutting edge portions 52a on the radially outer side. That is, with the second end cutting edges 52, the cutting amount of the workpiece by the first end cutting edges 35 during one turn can be made uniform in the radial direction. Consequently, with the thread mill 50, it is possible to further reduce tilting of an internal thread to be cut, thus further increasing the tool life of the thread mill 50.

A gash cutting edge 54 formed by a ridge between the gash face 43 and the flute bottom 45 of a gash 41, and the rake face 32 of a gash 40 are connected with ends of a second end cutting edge 52 and a non-functional cutting edge portion 52b on the axis C side. In FIG. 5, the gash cutting edge 54 connected with the second end cutting edge 52 is indicated by a broken line. Additionally, similarly to FIG. 2, FIG. 5 schematically shows the width W2 of the flute bottom 45 of the gash 41, and the gash opening angle θ5 of the gash 41.

In the present embodiment, the width W1 of the flute bottom 44 of the gash 40 and the width W2 of the flute bottom 45 are identical. On the other hand, the gash opening angle θ5 of the gash 40 is larger than the gash opening angle θ4 thereof. Accordingly, the gash cutting edge 54 is relieved toward the shank end 13 and radially outward at portions other than the flute bottoms 44, 45, relative to the gash cutting edge 46, so that the gash cutting edge 54 is less likely to cut the workpiece. Consequently, the cutting amount of the workpiece by the gash cutting edge 46 during one turn can be increased, thus possibly increasing the tool life of the thread mill 50.

The widths W1 and W2 are identical, and the gash opening angle θ5 is larger than the gash opening angle θ4. Accordingly, on the flute bottom 44, 45 side of the gashes 40, 41, the thickness of the tool body 12 at a position radially outward of the gashes 40, 41 can be easily made uniform in the circumferential direction. This makes it possible to make the rigidity of the tool body 12 uniform at that position in the circumferential direction, thus increasing the durability of the thread mill 50.

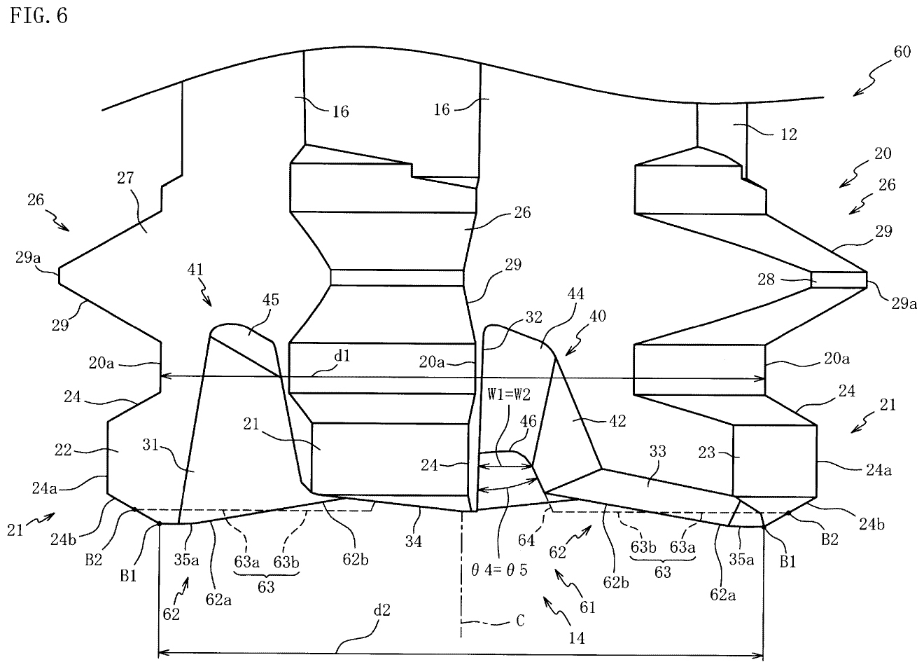

Next, a third embodiment will be described with reference to FIG. 6. The first embodiment describes a case where the first end cutting edges 35 are entirely constituted by functional cutting edge portions, and the second end cutting edges 36 are entirely constituted by non-functional cutting edge portions. In contrast, the third embodiment describes a case where functional cutting edge portions 35a, 62a, 63b and non-functional cutting edge portions 62b, 63a are partly present in a first end cutting edge 62 and a second end cutting edge 63, respectively. Portions that are identical to those described in the first embodiment are denoted by identical reference characters, and description thereof have been omitted.

FIG. 6 is a partial enlarged front view of a thread mill 60 according to the third embodiment. The upper side on the drawing sheet of FIG. 6 corresponds to the shank end 13 side. Also, FIG. 6 shows a case where the first end cutting edges 62 are located on left and right sides on the drawing sheet relative to the axis C. Additionally, in FIG. 6, the second end cutting edges 63 when the thread mill 60 (tool body 12) is caused to turn by 90° about the axis C from the aforementioned state without being helically fed are indicated by broken lines.

A second cutting edge portions 61 of the thread mill 60 is a part that cuts a drill hole having a diameter corresponding to the inner diameter of the internal thread. Similarly to the first embodiment, the second cutting edge portion 61 is formed at the front end 14 of the tool body 12 so as to be circumferentially divided by a plurality of (in total, four) gashes 40, 41 recessed at the front end 14.

The second cutting edge portion 61 includes a plurality of rake faces 31, 32, a plurality of flank faces 33, 34, and a plurality of first end cutting edges 62 and second end cutting edges 63. Ridges between the rake faces 31 and the corresponding flank faces 33 form the first end cutting edge 62. Ridges between the rake faces 32 and the corresponding flank faces 34 form the second end cutting edge 63. The first end cutting edges 62 and the second end cutting edges 63 are disposed circumferentially alternately, and are formed rotationally symmetrical about the axis C.

Each of the first end cutting edge 62 and the second end cutting edge 63 is a part that partially bites into a workpiece to cut the workpiece. Of the first end cutting edge 62, portions projecting toward the axial front end 14 relative to the trajectories of the second end cutting edge 63 when the thread mill 60 is caused to make one rotation about the axis C without being helically fed are constituted by the functional cutting edge portions 35a, 62a, and portions relieved toward the axial shank end 13 are constituted by the non-functional cutting edge portions 62b.

The functional cutting edge portions 35a are formed identical to the outer end cutting edges 35a in the first embodiment. The functional cutting edge portions 62a and the non-functional cutting edge portions 62b are formed identical to the inner end cutting edges 35b in the first embodiment. The boundary B1 between the first end cutting edge 62 and the corresponding thread cutting edges 24 is identical to the boundary B in the first embodiment.

Of the second end cutting edge 63, portions projecting toward the axial front end 14 relative to the trajectories of the first end cutting edges 62 when the thread mill 60 is caused to make one rotation about the axis C without being helically fed are constituted by the functional cutting edge portions 63b, and portions relieved toward the axial shank end 13 are constituted by the non-functional cutting edge portions 63a.

The non-functional cutting edge portions 63a are connected with the flanks 24b of the corresponding front cutting edges 24. The functional cutting edge portions 63b are connected with the corresponding non-functional cutting edge portions 63a on the axis C side. The non-functional cutting edge portions 63a and the functional cutting edge portions 63b are formed in a straight line toward the axis C from the boundary B2 between the second end cutting edges 63 and the corresponding thread cutting edges 24, and are parallel to the virtual plane P (see FIG. 2) orthogonal to the axis C.

The boundary B2 is located radially outward of the boundary B1 and toward the shank end 13. That is, the thread cutting edges 24 connected with the corresponding second end cutting edges 63 are formed by cutting portions located on the front end 14 side relative to the thread cutting edges 24 connected with the corresponding first end cutting edges 62. This can further prevent the second end cutting edges 63 from coming into contact with the workpiece.

With the thread mill 60 as described above, the cutting amounts of the workpiece by the functional cutting edge portions 35a, 62a, 63b during one turn are increased due to the presence of the non-functional cutting edge portions 62b, 63a, as compared with conventional thread mills in which a plurality of end cutting edges are entirely constituted by functional cutting edge portions. Consequently, it is possible to reduce tilting of an internal thread to be cut by the thread mill 60, thus making it possible to increase the tool life of the thread mill 60.

In the present embodiment, the functional cutting edge portions 35a, 62a, 63b and the non-functional cutting edge portions 62b, 63a are partly present on the first end cutting edge 62 and second end cutting edge 63, respectively. Accordingly, it is possible to prevent only one of the first end cutting edge 62 and the second end cutting edge 63 from becoming susceptible to wear due to cutting using the thread mill 60.

The gash cutting edge 64 formed by a ridge between the gash faces 43 and the flute bottom 45 of a gash 41 and the rake face 32 of a gash 40 is connected with an end on the axis C side of the functional cutting edge portion 63b of a second end cutting edge 63. In FIG. 6, the gash cutting edge 64 connected with the second end cutting edge 63 is indicated by a broken line. Additionally, similarly to FIG. 2, FIG. 6 schematically shows the width W2 of the flute bottom 45 of the gash 41, and the gash opening angle θ5 of the gash 41.

In the present embodiment, the width W1 of the flute bottom 44 of the gash 40 and the width W2 of the flute bottom 45 are identical. Furthermore, the gash opening angle θ4 and the gash opening angle θ5 of the gash 40 are identical. Note that, in this case as well, the second end cutting edge 63 side of the gash cutting edge 64 extends toward the front end 14 relative to the gash cutting edge 46 connected with the first end cutting edge 62. Accordingly, the gash cutting edge 46 is less likely to cut the workpiece. Consequently, the cutting amount of the workpiece by the gash cutting edge 64 during one turn can be increased, thus possibly increasing the tool life of the thread mill 60.

Furthermore, the trajectories of the plurality of gash cutting edges 46, 64 when the thread mill 60 (tool body 12) is caused to make one rotation about the axis C overlap each other. In the case of cutting the workpiece not only by the first end cutting edges 62 and the second end cutting edges 63, but also by the gash cutting edges 46, 64, each of the plurality of gash cutting edges 46, 64 can be easily brought into contact with the workpiece, and the radial deformation of the thread mill 60 corresponding to the manner of such contact can be made as uniform as possible in the circumferential direction. Accordingly, it is possible to prevent the occurrence of vibration induced by such nonuniform radial deformation in the thread mill 60, thus suppressing a reduction in the tool life of the thread mill 60 due to such vibration.

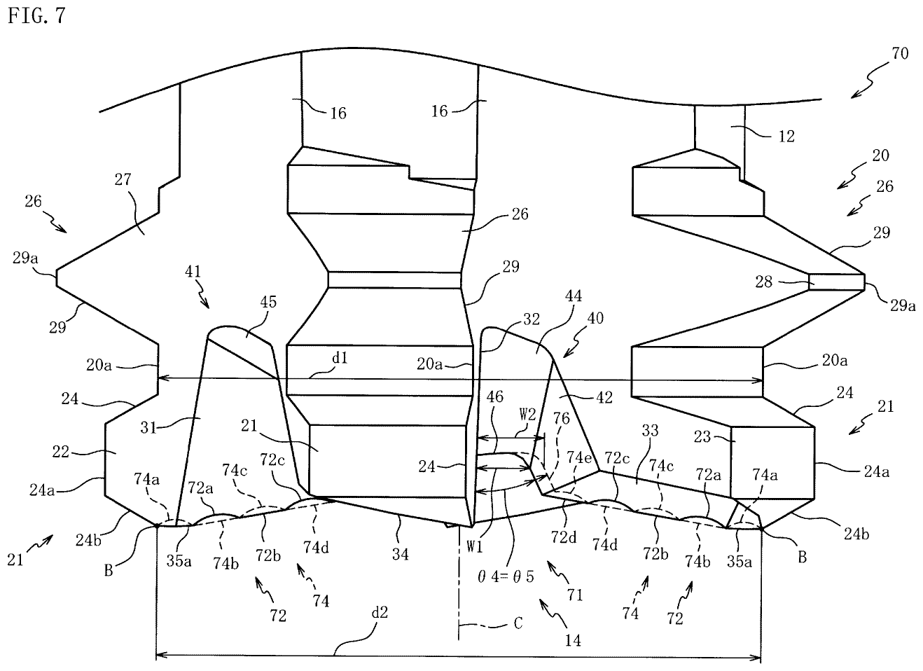

Next, a fourth embodiment will be described with reference to FIG. 7. The first embodiment describes a case where the first end cutting edges 35 are entirely constituted by functional cutting edge portions, and the second end cutting edges 36 are entirely constituted by non-functional cutting edge portions. In contrast, the fourth embodiment describes a case where functional cutting edge portions 35a, 72b, 72d, 74b, 74d and non-functional cutting edge portions 72a, 72c, 74a, 74c, 74e are alternately provided on a first end cutting edge 72 and a second end cutting edge 74, respectively. Portions that are identical to those described in the first embodiment are denoted by identical reference characters, and descriptions thereof have been omitted.

FIG. 7 is a partial enlarged front view of a thread mill 70 according to the fourth embodiment. The upper side on the drawing sheet of FIG. 7 corresponds to the shank end 13 side. Also, FIG. 7 shows a case where the first end cutting edges 72 are located on left and right sides on the drawing sheet relative to the axis C. Additionally, in FIG. 7, the second end cutting edges 74 when the thread mill 70 (tool body 12) is caused to turn by 90° about the axis C from the aforementioned state without being helically fed are indicated by broken lines.

The second cutting edge portion 71 of the thread mill 70 is a part that cuts a drill hole having a diameter corresponding to the inner diameter of the internal thread. Similarly to the first embodiment, the second cutting edge portion 71 is formed at the front end 14 of the tool body 12 so as to be circumferentially divided by a plurality of (in total, four) gashes 40, 41 recessed at the front end 14.

The second cutting edge portion 71 includes a plurality of rake faces 31, 32, a plurality of flank faces 33, 34, and a plurality of first end cutting edges 72 and second end cutting edges 74s. Ridges between the rake faces 31 and the corresponding flank faces 33 form the first end cutting edge 72. Ridges between the rake faces 32 and the corresponding flank faces 34 form the second end cutting edge 74. The first end cutting edges 72 and the second end cutting edges 74 are disposed circumferentially alternately, and are formed rotationally symmetrical about the axis c.

Each of the first end cutting edge 72 and the second end cutting edge 74 is a part that partially bites into a workpiece to cut the workpiece. Of the first end cutting edge 72, portions projecting toward the axial front end 14 relative to the trajectories of the second end cutting edge 74 when the thread mill 70 is caused to make one rotation about the axis C without being helically fed are constituted by the functional cutting edge portions 35a, 72b, 72d, and portions relieved toward the axial shank end 13 are constituted by the non-functional cutting edge portions 72a, 72c.

The functional cutting edge portions 35a are formed identical to the outer end cutting edges 35a of the first embodiment. A non-functional cutting edge portion 72a, a functional cutting edge portion 72b, a non-functional cutting edge portion 72c, and a functional cutting edge portion 72d are connected in this order from a functional cutting edge portion 35a toward the axis C. Portions recessed toward the shank end 13 relative to the inner end cutting edge 35b in the first embodiment are constituted by the non-functional cutting edge portions 72a, 72c, and portions formed identical to the inner end cutting edge 35b are constituted by the functional cutting edge portions 72b, 72d.

Of the second end cutting edge 74, portions projecting toward the axial front end 14 relative to the trajectories of the first end cutting edge 72 when the thread mill 70 is caused to make one rotation about the axis C without being helically fed are constituted by the functional cutting edge portions 74b, 74d, and portions relieved toward the axial shank end 13 are constituted by the non-functional cutting edge portions 74a, 74c, 74e.

A non-functional cutting edge portion 74a, a functional cutting edge portion 74b, a non-functional cutting edge portion 74c, a functional cutting edge portion 74d, and a non-functional cutting edge portion 74e are connected in this order from the boundary B between the second end cutting edge 74 and the thread cutting edge 24 toward the axis C. Portions recessed toward the shank end 13 relative to the first end cutting edge 35 in the first embodiment are constituted by the non-functional cutting edge portions 74a, 74c, 74e, and portions formed identical to the first end cutting edge 35 are constituted by the functional cutting edge portions 74b, 74d.

With the thread mill 70 as described above, the cutting amounts of the workpiece by the functional cutting edge portions 35a, 72b, 72d, 74b, 74d during one turn are increased due to the presence of the non-functional cutting edge portions 72a, 72c, 74a, 74c, 74e, as compared with conventional thread mills in which a plurality of end cutting edges are entirely constituted by functional cutting edge portions. Consequently, it is possible to reduce tilting of an internal thread to be cut by the thread mill 70, thus increasing the tool life of the thread mill 70.

In the present embodiment, the functional cutting edge portions 35a, 72b, 72d, 74b, 74d, and non-functional cutting edge portions 72a, 72c, 74a, 74c, 74e are alternately provided on the first end cutting edge 72 and the second end cutting edge 74, respectively. Thus, the non-functional cutting edge portions 72a, 72c, 74a, 74c, 74e function as nicks, so that chips produced by the functional cutting edge portions 35a, 72b, 72d, 74b, 74d can be crushed into fine pieces. Consequently, it is possible to prevent clogging of chips produced during a cutting operation using the thread mill 70.

The gash cutting edge 76 formed by a ridge between the gash face 43 and the flute bottom 45 of the gash 41 and the rake face 32 of the gash 40 is connected with and end, on the axis C side, of the non-functional cutting edge portion 74e of a second end cutting edge 74. In FIG. 7, the gash cutting edge 76 connected with the second end cutting edge 74 is indicated by a broken line. Additionally, similarly to FIG. 2, FIG. 7 schematically shows the width W2 of the flute bottom 45 of the gash 41, and the gash opening angle θ5 of the gash 41.

In the present embodiment, the gash opening angle θ4 and the gash opening angle θ5 of the gash 40 are identical. On the other hand, the width W2 of the flute bottom 45 of the gash 40 is larger than the width W1 of the flute bottom 44 thereof. Accordingly, at portions other than the flute bottoms 44, 45, the gash cutting edge 76 is relieved toward the shank end 13 and radially outward, relative to the gash cutting edge 46, and is less likely to cut the workpiece.

Consequently, the cutting amount of the workpiece by the gash cutting edge 46 during one turn can be increased, thus possibly increasing the tool life of the thread mill 70.

Furthermore, in the present embodiment, the width W2 is increased relative to the width W1. Accordingly, as also described in the first embodiment, it is possible to further expand the chip room formed by the gash 41 as compared with a case where the gash opening angle θ5 is simply increased relative to the gash opening angle θ4. Therefore, in this case, it is possible to prevent clogging of chips during a cutting operation using the thread mill 70.

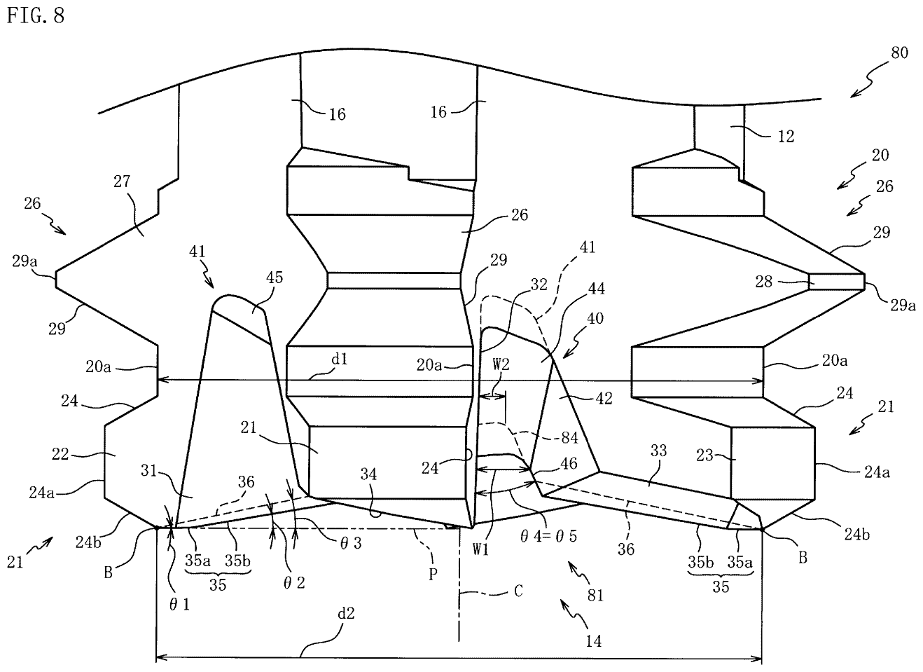

Next, a fifth embodiment will be described with reference to FIG. 8. The first to fourth embodiments describe cases where the depths of the gashes 40, 41 are identical to each other. In contrast, the fifth embodiment describes a case where the depth of the gash 41 is larger than the depth of the gash 40. Portions that are identical to those described in the first embodiment are denoted by identical reference characters, and descriptions thereof have been omitted.

FIG. 8 is a partial enlarged front view of a thread mill 80 according to the fifth embodiment. The upper side on the drawing sheet of FIG. 8 corresponds to the shank end 13 side. Also, FIG. 8 shows a case where the first end cutting edges 35 are located on left and right sides on the drawing sheet relative to the axis C. Additionally, in FIG. 8, the second end cutting edges 36, and part of the gash 41 when the thread mill 80 (tool body 12) is caused to turn by 90°about the axis C from the aforementioned state without being helically fed are indicated by broken lines.

The second cutting edge portion 81 of the thread mill 80 is a part that cuts a drill hole having a diameter corresponding to the inner diameter of the internal thread.

Similarly to the first embodiment, the second cutting edge portion 81 is formed at the front end 14 so as to be circumferentially divided by a plurality of (in the present embodiment, four) gashes 40, 41 recessed at the front end 14 of the tool body 12. The second cutting edge portions 81 are formed identical to that of the first embodiment except that the dimensions of the gashes 41 are different.

On the second cutting edge portion 81, a gash cutting edge 84 formed by a ridge between the gash face 43 and the flute bottom 45 of a gash 41 and the rake face 32 of a gash 40 is connected with an end of the second end cutting edge 36 on the axis C. In FIG. 8, the gash cutting edge 84 connected with the second end cutting edge 36 is indicated by a broken line. Additionally, similarly to FIG. 2, FIG. 8 schematically shows the width W2 of the flute bottom 45 of the gash 41, and the gash opening angle θ5 of the gash 41.

In the present embodiment, the gash opening angle θ4 and the gash opening angle θ5 of the gash 40 are identical. On the other hand, the width W2 of the flute bottom 45 is smaller than the width W1 of the flute bottom 44 of the gash 40. Furthermore, the depth of the gash 41 is larger than the depth of the gash 40. Note that the widths W1, W2, and the depths of the gashes 40, 41 are set such that trajectories of the plurality of gash cutting edges 46, 84 when the thread mill 80 (tool body 12) is caused to make one rotation about the axis C overlap each other on the first end cutting edge 35 side and the second end cutting edge 36 side. Accordingly, similarly to the third embodiment, it is possible to suppress a reduction in the tool life of the thread mill 80 due to nonuniform radial deformation.

Here, chips produced by cutting with the first end cutting edges 35 are housed mainly in the gashes 41 (chip rooms) forming the rake faces 31 of the first end cutting edges 35. Also, chips produced by cutting with the second end cutting edges 36 are housed mainly in the gashes 40 (chip rooms) forming the rake faces 32 of the second end cutting edges 36.

Since the second end cutting edges 36 constituted by the non-functional cutting edge portions are less likely to cut the workpiece, a relatively small amount of chips is housed in the gashes 40. On the other hand, the workpiece is mainly cut by the first end cutting edges 35 constituted by the functional cutting edge portions, and therefore a relatively large amount of chips is housed in the gashes 41. Since the depth of the gashes 41 is larger than the depth of the gashes 40, it is possible to increase the internal space of the gashes 41 in which a large amount of chips are housed, while reducing the internal space of the gashes 40 in which a smaller amount of chips are housed. Accordingly, it is possible to prevent clogging of chips during a cutting operation with the thread mill 80, and ensure the rigidity of the tool body 12, thus increasing the tool life of the thread mill 80.

Next, a durability test of a thread mill will be described. For this durability test, a thread mill according to an example having specific dimensions, and a thread mill according to a comparative example obtained by partially changing the thread mill according to the example were used. The example was configured based on the thread mill 80, with the depth of the gashes 40 and the depth of the gashes 41 set to be identical, and the width W1 of the flute bottoms 44 and the width W2 of the flute bottoms 45 set to be identical. The rest of the configuration of the example was identical to that of the thread mill 80.

In the example, the tool diameter was set to 3.1 mm, the axial dimension of the under-head portion of the tool body 12 was set to 18 mm, the widths W1, W2 were set to 0.09 mm, the angle θ1 was set to 1°, the angle θ2 was set to 10°, the angle θ3 was set to 12°, and the gash opening angles θ4, θ5 were set to 30°. The comparative example was configured in the same manner as the example except that all of the second end cutting edges 36 were changed to the first end cutting edges 35.

The durability test evaluated how many internal threads were formed in SKD11 (60HRC) serving as a workpiece by each of the example and the comparative example held by a horizontal machining center (driving apparatus). Internal threads to be cut had a nominal diameter of M4×0.7, a tapping length of 12 mm (3D), and was of grade 6H defined by the ISO standard.

More specifically, the tool radius offset was adjusted such that a step gauge with a pitch diameter of +0.080 could advance into the internal threads 1.5 turns or more, but a step gauge with a pitch diameter of +0.100 could not advance more than one turn, and the durability test was started. The durability test was stopped when a step gauge with a pitch diameter of +0.020 could not advance 17 turns, and the durability test was restarted after tool radius correction. The number of passes was set to one. In addition, air blow was used as the coolant, the cutting speed was 45 m/min, and the feed rate per edge was 0.02 mm/t.

The durability test was ended when the pitch diameter difference (tilting of internal threads) between the hole entrance and the hole bottom of the formed internal threads was 0.1 mm or more. Furthermore, the durability test was also ended when the tool was broken, and when no further tool radius correction was possible.

The results of the durability test will be described. With the example, a total of 74 internal threads were confirmed to be formed. On the other hand, with the comparative example, a total of 30 internal threads were confirmed to be formed. Accordingly, it was revealed that, as compared with the comparative example including no second end cutting edge 36, the example including the second end cutting edges 36 reduced the tilting of internal threads, thus making it possible to increase the tool life.

In the comparative example, the cutting amount (feed rate per edge) of the workpiece by one thread cutting edge 24 during one turn was 0.02 mm, and the cutting amount (feed rate per edge) of the workpiece by one first end cutting edge 35 during one turn was about 0.001114 mm. In contrast, in the example, the amount of cutting by the thread cutting edge 24 was identical to that of the comparative example, whereas the amount of cutting by the first end cutting edge 35 was approximately twice that of the comparative example.

Although the present invention has been described with reference to the embodiments and examples, it can be readily inferred that the invention is not limited to the embodiments, and various modifications can be made without departing from the scope of the invention. For instance, the numeric values used in the embodiments and examples are merely examples, and of course can be replaced with other numeric values, and the magnitude relationship between the numeric values may be changed as appropriate.

For example, the angle θ1 and the angle θ2 may be identical. The angle θ2 and the angle θ3 may be identical, and the angle θ3 may be smaller than the angle θ2. The minor diameter d1 and the diameter d2 may be different. The width W1 may be larger than the width W2. The gash opening angle θ4 may be larger than the gash opening angle θ5.

The above embodiments describe cases where the front thread portions 21 each having one thread, and the rear thread portions 26 each having one thread are provided. However, the present invention is not necessarily limited thereto. For example, the rear thread portions 26 may each have two or more threads. Also, the shape of the front thread portions 21 and the shape of the rear thread portions 26 may be identical.

The above embodiments describe a case where each of the first cutting edge portions 20 and the second cutting edge portions 30, 51, 61, 71, 81 is circumferentially divided into four sections by a plurality of flutes 16 and gashes 40, 41. However, the present invention is not necessarily limited thereto. For example, each of the first cutting edge portions 20 and the second cutting edge portions 30, 51, 61, 71, 81 may be circumferentially divided into two sections, three sections, or five or more sections by the plurality of flutes 16 and gashes 40, 41.

The above embodiments describe cases where the first end cutting edges 35, 62, 72 and the second end cutting edges 36, 52, 63, 74 are disposed circumferentially alternately.

However, the present invention is not necessarily limited thereto. Two or more first end cutting edges 35, 62, 72 and two or more second end cutting edges 36, 52, 63, 74 may be disposed circumferentially successively. Also, end cutting edges different from the first end cutting edges 35, 62, 72 and the second end cutting edges 36, 52, 63, 74 may be provided. The plurality of end cutting edges are preferably formed rotationally symmetrical about the axis C, but need not be formed rotationally symmetrical.

Part of the configurations of any of the above embodiments may be applied to the other embodiments. For example, the non-functional cutting edge portions may be formed on the first end cutting edges 35, 62, 72 and the second end cutting edges 36, 52, 74 of the first, second, fourth, and fifth embodiments by removing some of the thread cutting edges 24 as in the third embodiment. Also, the nicks described in the fourth embodiment may be formed on the first end cutting edges 35, 62, 72 and the second end cutting edges 36, 52, 63, 74 of the first to third, and fifth embodiments.

As in the fifth embodiment, the depth of the gash 41 in the first to fourth embodiments may be larger than the depth of the gash 40. Also, the depths of the gashes 40 and 41 in the fifth embodiment may be identical to each other.

Furthermore, the depth of the gash 40 in each of the embodiments may be larger than the depth of the gash 41.

### DESCRIPTION OF REFERENCE NUMERALS

10, 50, 60, 70, 80 thread mill
12 tool body
13 shank end
14 front end
20a root (part of thread cutting edge)
24 front cutting edge (part of thread cutting edge)
29 rear cutting edge (part of thread cutting edge)
35 first end cutting edge (functional cutting edge portion)
62, 72 first end cutting edge
36 second end cutting edge (non-functional cutting edge portion)
52, 63, 74 second end cutting edge
35a, 52a, 62a, 63b, 72b, 72d, 74b, 74d functional cutting edge portion
52b, 62b, 63a, 72a, 72c, 74a, 74c, 74e non-functional cutting edge portion
40, 41 gash
42, 43 gash face
44, 45 flute bottom
46, 47, 54, 64, 76, 84 gash cutting edge
C axis

1. A thread mill that cuts an internal thread in a workpiece by moving relative to the workpiece while rotating about an axis, the thread mill comprising:
a tool body including an axial front end, and a shank end located axially opposite to the front end, and having a shaft shape centered around the axis;
a plurality of thread cutting edges that are each formed by a plurality of axially arranged threads, and that are circumferentially spaced apart on the front end side of an outer circumference of the tool body; and
a plurality of end cutting edges formed at the front end of the tool body so as to be respectively connected with the plurality of thread cutting edges on the front end side, wherein
a functional cutting edge portion that cuts the workpiece, and a non-functional cutting edge portion that is axially relieved toward the axial shank end relative to a trajectory of the functional cutting edge portion when the tool body is caused to make one rotation about the axis, are formed on the plurality of end cutting edges.

2. The thread mill according to claim 1, wherein each of the end cutting edges is entirely formed by either the functional cutting edge portion or the non-functional cutting edge portion.

3. The thread mill according to claim 1, or further comprising a plurality of gashes that are recessed at the front end so as to respectively form rake faces of the plurality of end cutting edges, and that are in communication with each other on the axis side thereof, wherein
each of the gashes includes:
a gash face to which the corresponding rake face is circumferentially opposed, and whose opposed interval with the rake face is narrowed toward the shank end; and
a flute bottom that joins each of the gash faces and the corresponding rake face, that extends from the axis side toward the outer circumference of the tool body, and that is inclined toward the shank end,
a ridge between the rake face of one of the two gashes that are circumferentially adjacent to each other, and the gash face of the other of the two gashes forms a plurality of gash cutting edges respectively connected with the plurality of end cutting edges, and
trajectories of the plurality of gash cutting edges when the tool body is caused to make one rotation about the axis overlap each other at least on the end cutting edge side.

4. The thread mill according to claim 3, wherein
each of the end cutting edges is entirely formed by either the functional cutting edge portion or the non-functional cutting edge portion, and
a depth, from the front end side to the flute bottom, of the gash forming the rake face of the functional cutting edge portion is larger than a depth, from the front end side to the flute bottom, of the gash forming the rake face of the non-functional cutting edge portion.

5. The thread mill according to claim 1, wherein the functional cutting edge portion and the non-functional cutting edge portion are disposed circumferentially alternately.

6. The thread mill according to claim 1, wherein the plurality of end cutting edges are formed rotationally symmetrical about the axis.
